(19) United States
(12) Patent Application Publication
(10) Pub. No.: US 2022/0055659 A1
(43) Pub. Date: Feb. 24, 2022

(54) MODE SELECTION ACCORDING TO SYSTEM CONDITIONS

(71) Applicants: Denso International America, Inc., Southfield, MI (US); Denso Corporation, Kariya-city (JP)

(72) Inventor: Yu Zhang, Farmington Hills, MI (US)

(21) Appl. No.: 17/188,505

(22) Filed: Mar. 1, 2021

Related U.S. Application Data
(60) Provisional application No. 63/067,986, filed on Aug. 20, 2020.

(51) Int. Cl. B60W 60/00; B60W 50/14; B60W 30/08; B60W 30/182; G05D 1/00

(52) U.S. Cl. CPC B60W 60/0015; B60W 50/14; B60W 30/08; B60W 2554/4045; G05D 1/0061; B60W 2050/146; B60W 2552/53; B60W 30/182

(57) ABSTRACT

Systems, methods, and other embodiments described herein relate to providing cooperative control according to system conditions of a vehicle. In one embodiment, a method includes determining a system condition associated with operation of functions associated with an assistance system within an ego vehicle. The system condition is based, at least in part, on environmental conditions around the ego vehicle. The method includes defining available modes according to which control modes of the ego vehicle can operate with the system condition. The method includes controlling the ego vehicle according to a selected mode of the available modes.

### CROSS-REFERENCE TO RELATED APPLICATION

This application claims benefit of U.S. Provisional Application No. 63/067,986, filed on Aug. 20, 2020, which is herein incorporated by reference in its entirety.

### TECHNICAL FIELD

The subject matter described herein relates in general to systems and methods for providing cooperative control according to system conditions of a vehicle, and, more particularly, to determining when functions of the vehicle may be impeded and selectively adapting assistance provided to an operator of the vehicle.

### BACKGROUND

Perceiving an environment can be an important aspect for many different computational functions, such as automated vehicle assistance systems. Moreover, different driving conditions, such as adverse weather, can be difficult for a human operator and also for automated vehicle assistance systems to operate a vehicle. For example, in conditions where lane lines on a road are not visible, a lane-keeping assistance system is generally unable to operate. As a further example, in conditions that are slippery, an adaptive cruise control system may function but may not provide appropriate distances for the reduced friction of the roadway. Similarly, operators may have equal difficulty in such adverse conditions. Thus, assistance systems can be unreliable during instances when an operator is in greatest need.

### SUMMARY

In one embodiment, example systems and methods associated with providing cooperative control according to system conditions of a vehicle are disclosed. As previously noted, adverse weather conditions can cause difficulties for both automated assistance systems and human operators of a vehicle. Systems, such as lane-keeping assistance, adaptive cruise control, collision avoidance, and others may not function optimally when roads become slippery, lane markers are no longer visible, and so on.

Therefore, in one embodiment, a disclosed approach includes providing information that the assistance system can acquire to assist an operator and, when possible, providing assistance with controls. For example, a monitoring system initially monitors the functioning of one or more assistance systems, such as a lane-keeping system. Thus, the monitoring system may, in one configuration, acquire state information, including the current state of how various aspects of the assistance system are operating, availability of sensor data of different modalities (e.g., GPS), and so on. The current state of the assistance system may indicate whether a lane identifying function is able to acquire lane markings, acquire fixes on nearby dynamic objects (e.g., trajectories of nearby vehicles), and so on.

With the state information, the monitoring system can define the system conditions, which generally outline whether various functions of the assistance system are currently operable or not. As such, the monitoring system can then define available modes, such as trace mode, separation mode, base mode, which are associated with different levels of the functions that may be available. Accordingly, the monitoring system can then display the available modes to an operator for selection or prompt to the operator when the current mode is no longer available. Once the monitoring system receives an input selecting one of the modes, the monitoring system can control the vehicle according to the selected mode. Controlling the vehicle may include providing actual lateral and/or longitudinal inputs to control a path and/or generating a mode interface that is displayed to the operator. The mode interface can include various information to assist the operator in controlling the vehicle. For example, the mode interface may include visuals indicating locations of objects, suggestions for optimally controlling the vehicle (e.g., speed, distances, etc.), and so on. In this way, the disclosed approach provides for improving operation in adverse circumstances when various systems may otherwise be impaired.

In one embodiment, a monitoring system is disclosed. The monitoring system includes one or more processors and a memory that is communicably coupled to the one or more processors. The memory stores an interface module including instructions that, when executed by the one or more processors, cause the one or more processors to determine a system condition associated with the operation of functions associated with an assistance system within an ego vehicle. The system condition being based, at least in part, on environmental conditions around the ego vehicle. The interface module includes instructions to define available modes according to which control modes of the ego vehicle can operate with the system condition. The interface module includes instructions to control the ego vehicle according to a selected mode of the available modes.

In one embodiment, a non-transitory computer-readable medium is disclosed. The computer-readable medium stores instructions that, when executed by one or more processors, cause the one or more processors to perform the disclosed functions. The instructions include instructions to determine a system condition associated with operation of functions associated with an assistance system within an ego vehicle. The system condition being based, at least in part, on environmental conditions around the ego vehicle. The instructions include instructions to define available modes according to which control modes of the ego vehicle can operate with the system condition. The instructions include instructions to control the ego vehicle according to a selected mode of the available modes.

In one embodiment, a method is disclosed. In one embodiment, a method includes determining a system condition associated with the operation of functions associated with an assistance system within an ego vehicle. The system condition being based, at least in part, on environmental conditions around the ego vehicle. The method includes defining available modes according to which control modes of the ego vehicle can operate with the system condition. The method includes controlling the ego vehicle according to a selected mode of the available modes.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a configuration of a vehicle in which example systems and methods disclosed herein may operate.

FIG. 2 illustrates one embodiment of a monitoring system that is associated with enhancing sensor outputs.

FIG. 3 illustrates one embodiment of a method associated with providing cooperative control according to system conditions of a vehicle.

FIG. 4 illustrates one example of a mode interface for a trace mode.

FIG. 5 illustrates an example of a mode interface for a separation mode.

FIG. 6 illustrates an example of a mode interface for a trace mode.

FIG. 7 illustrates one embodiment of a method associated with providing cooperative control.

FIG. 8 illustrates one embodiment of a method associated with selecting a default mode.

### DETAILED DESCRIPTION

Systems, methods, and other embodiments associated with providing cooperative control according to system conditions of a vehicle are disclosed. As previously noted, adverse weather conditions can cause difficulties for both automated assistance systems and human operators of a vehicle. Systems, such as lane-keeping assistance, adaptive cruise control, collision avoidance, and others may not function optimally when roads become slippery, lane markers are no longer visible, and so on. This can be because of reductions in friction between tires and the road surface, the ability of sensors to perceive lane markings and other objects, and so on.

Therefore, in one embodiment, a disclosed approach includes providing information about what information the assistance system can acquire to further inform an operator regarding operation of the vehicle and aspects of the surroundings and also, when possible, providing assistance with controls of the vehicle itself. For example, a monitoring system initially monitors the functioning of one or more aspects of the assistance system, such as a lane-keeping function. Thus, the monitoring system may, in one configuration, acquire state information, including the current state of how various aspects of the assistance system are operating, availability of sensor data of different modalities (e.g., GPS), and so on. The current state of the assistance system may indicate whether a lane identifying function is able to acquire lane markings, acquire fixes on nearby dynamic objects (e.g., trajectories of nearby vehicles), and so on.

With the state information, the monitoring system can define the system conditions, which generally outline whether various functions of the assistance system are currently operable or not. As such, the monitoring system can then define available modes, such as trace mode, separation mode, base mode, which are associated with different levels of the functions that may be available. Accordingly, the monitoring system can then display the available modes to an operator for selection. Once the monitoring system receives an input selecting one of the modes, the monitoring system can control the vehicle according to the selected mode. Controlling the vehicle may include providing actual lateral and/or longitudinal inputs to control a path and/or generating a mode interface that is displayed to the operator. The mode interface can include various information to assist the operator in controlling the vehicle. For example, the mode interface may include visuals indicating locations of objects, suggestions for optimally controlling the vehicle (e.g., speed, following distances, etc.), and so on. In this way, the disclosed approach provides for improving operation in adverse circumstances when various systems may otherwise be impaired.

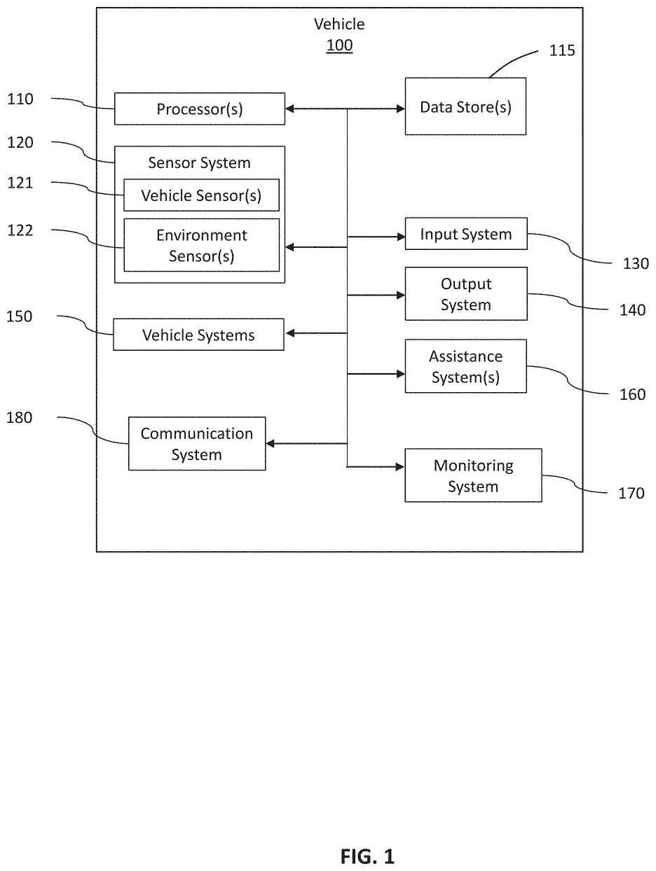

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any form of transport that, for example, includes the noted assistance system, and thus benefits from the functionality discussed herein.

The vehicle 100 also includes various elements. It will be understood that, in various embodiments, the vehicle 100 may not have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances and provided as remote services (e.g., cloud-computing services).

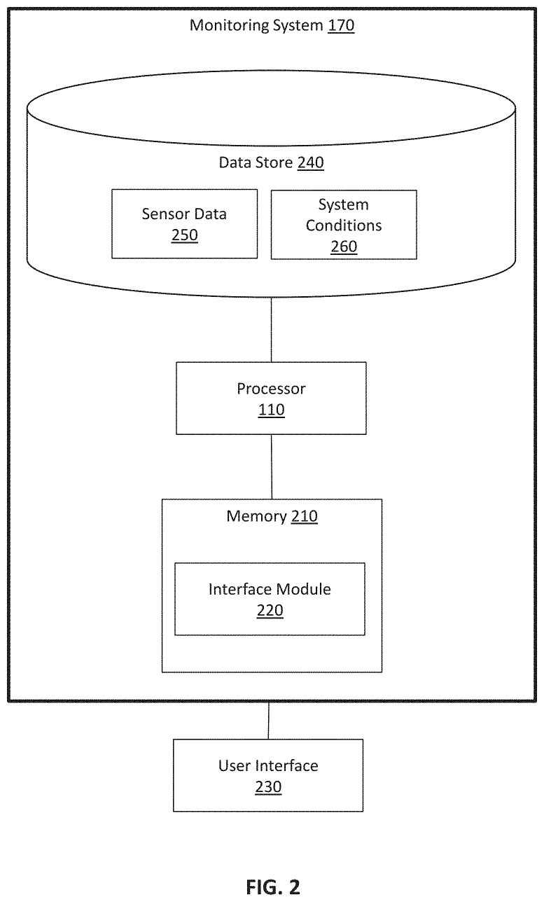

Some of the possible elements of the vehicle 100 are shown in FIG. 1 and will be described along with subsequent figures. A description of many of the elements in FIG. 1 will be provided after the discussion of FIGS. 2-6 for purposes of the brevity of this description. Additionally, it will be appreciated that for simplicity and clarity of illustration, where appropriate, reference numerals have been repeated among the different figures to indicate corresponding, analogous, or similar elements. Furthermore, it should be understood that the embodiments described herein may be practiced using various combinations of the described elements.

In either case, the vehicle 100 includes a monitoring system 170 that functions to improve cooperative control according to system conditions that may relate to weather conditions in a surrounding environment, current sensor status, and so on. Moreover, while depicted as a standalone component, in one or more embodiments, the monitoring system 170 is integrated with the assistance system 160, or another similar system of the vehicle 100 to facilitate functions of the other systems/modules. The noted functions and methods will become more apparent with a further discussion of the figures.

Furthermore, the assistance system 160 may take many different forms but generally provides some form of automated assistance to an operator of the vehicle 100. For example, the assistance system 160 may include various advanced driving assistance system (ADAS) functions, such as a lane-keeping function, adaptive cruise control, collision avoidance, emergency braking, and so on. In further aspects, the assistance system 160 may be a semi-autonomous or fully autonomous system that can partially or fully control the vehicle 100. Accordingly, the assistance system 160, in whichever form, functions in cooperation with sensors of the sensor system 120 to acquire observations about the surrounding environment from which additional determinations can be derived in order to provide the various functions. However, where a sensor is not functioning, the sensor data itself is of low quality due to weather or other issues, and/or the assistance system 160 encounters difficulties processing the sensor data, then various functions of the assistance system 170 may not operate effectively. However, even still, the assistance system 160 may retain information or partial functionality that can facilitate control of the vehicle 100 in either a partially automated form or by the operator.

As a further aspect, the vehicle 100 also includes a communication system 180. In one embodiment, the communication system 180 communicates according to one or more communication standards. For example, the communication system 180 can include multiple different antennas/transceivers and/or other hardware elements for communicating at different frequencies and according to respective protocols. The communication system 180, in one arrangement, communicates via short-range communications such as a Bluetooth, WiFi, or another suitable protocol for communicating between the vehicle 100 and other nearby devices (e.g., other vehicles). Moreover, the communication system 180, in one arrangement, further communicates according to a long-range protocol such as global system for mobile communication (GSM), Enhanced Data Rates for GSM Evolution (EDGE), or another communication technology that provides for the vehicle 100 communicating with a cloud-based resource. In either case, the system 170 can leverage various wireless communications technologies to provide communications from a cloud-based resource, to nearby vehicles (e.g., vehicle-to-vehicle (V2V)), to nearby infrastructure elements (e.g., vehicle-to-infrastructure (V2I)), and so on.

With reference to FIG. 2, one embodiment of the monitoring system 170 is further illustrated. As shown, the monitoring system 170 includes a processor 110. Accordingly, the processor 110 may be a part of the monitoring system 170, or the monitoring system 170 may access the processor 110 through a data bus or another communication pathway. In one or more embodiments, the processor 110 is an application-specific integrated circuit that is configured to implement functions associated with an interface module 220. More generally, in one or more aspects, the processor 110 is an electronic processor such as a microprocessor that is capable of performing various functions as described herein when executing encoded functions associated with the monitoring system 170.

In one embodiment, the monitoring system 170 includes a memory 210 that stores the interface module 220. The memory 210 is a random-access memory (RAM), read-only memory (ROM), a hard disk drive, a flash memory, or other suitable memory for storing the module 220. The module 220 is, for example, computer-readable instructions that, when executed by the processor 110, cause the processor 110 to perform the various functions disclosed herein. While, in one or more embodiments, the module 220 is instructions embodied in the memory 210, in further aspects, the module 220 includes hardware such as processing components (e.g., controllers), circuits, etc. for independently performing one or more of the noted functions.

Furthermore, in one embodiment, the monitoring system 170 includes a data store 240. The data store 240 is, in one embodiment, an electronically-based data structure for storing information. For example, in one approach, the data store 240 is a database that is stored in the memory 210 or another suitable medium, and that is configured with routines that can be executed by the processor 110 for analyzing stored data, providing stored data, organizing stored data, and so on. In any case, in one embodiment, the data store 240 stores data used by the module 220 in executing various functions. In one embodiment, the data store 240 includes sensor data 250, and system conditions 260 (e.g., operating states) along with, for example, other information that is used by the module 220.

Accordingly, the interface module 220 generally includes instructions that function to control the processor 110 to acquire data inputs from one or more sensors of the vehicle 100 that form the sensor data 250. In general, the sensor data 250 includes information that embodies observations of the surrounding environment of the vehicle 100. The observations of the surrounding environment, in various embodiments, can include surrounding lanes, vehicles, objects, obstacles, etc. that may be present in the lanes, proximate to a roadway, within a parking lot, garage structure, driveway, or another area within which the vehicle 100 is traveling or parked. The sensor data 250 may further include sensor state information (i.e., operating state about how the sensor is functioning), information from vehicle sensors about the current operation of the vehicle (e.g., wheel slip sensors, inertial measurement unit (IMU) sensors, etc.), information about the current operating state of the assistance system 160 and associated devices (e.g., processor 110), and so on.

While the interface module 220 is discussed as controlling the various sensors to provide the sensor data 250, in one or more embodiments, the interface module 220 can employ other techniques to acquire the sensor data 250 that are either active or passive. For example, the interface module 220 may passively sniff the sensor data 250 from a stream of electronic information provided by the various sensors to further components within the vehicle 100. Moreover, the interface module 220 can undertake various approaches to fuse data from multiple sensors when providing the sensor data 250. Thus, the sensor data 250, in one embodiment, represents a combination of perceptions acquired from multiple sensors and/or other aspects of the vehicle 100. For example, in a further configuration, the sensor data 250 may include information acquired via the communication system 180, such as data from other vehicles and/or infrastructure devices about the average speed of traffic.

Thus, whether the sensor data 250 is derived from a single sensor, multiple sensors, or is acquired through other means, the sensor data 250 is comprised of various information that facilitates the interface module 220 with determining the system condition(s) 260. In general, the system conditions 260 indicate a current operating state of different functions of the assistance system 160. For example, the system conditions 260 may specify whether a lane-keeping function has a lane line acquisition from the sensor data 250, whether GPS location data is presently available, whether a path trace is available for a lead car, and so on.

In at least one arrangement, the interface module 220 analyzes the sensor data 250 to determine the system conditions 260. Thus, the interface module 220 may use a policy or a state determination heuristic to analyze the sensor data 250 and determine the system conditions 260 therefrom. By way of example, in at least configuration, the interface module 220 can determine environmental conditions, such as conditions associated with weather that may limit the visibility of sensors, alter friction between tires and a road surface, and so on. From these aspects, the interface module 220 can determine whether the functions of the assistance system 160 are presently functioning or able to function under normal operating assumptions, such as braking performance.

Accordingly, the interface module 220 may further correlate different control modes with the system conditions 260 in order to determine which control modes are available for assisting the operator. For example, the control modes may provide progressively more information and/or controls according to the available functions of the assistance system 160 as defined by the system conditions 260. By way of example, in relation to a trace mode, the interface module 220, in one approach, analyzes the system conditions 260 to determine whether the assistance system 160 is able to trace a path of a preceding vehicle (i.e., a vehicle traveling in front of the vehicle 100). The interface module 220 may derive this determination from information about the sensors themselves (e.g., present operating status), outputs of functions in the assistance system 160 (e.g., identifying paths, lane lines, objects, etc.), and so on. Thus, depending on the system conditions 260, the interface module 220 may determine which control modes to indicate are available.

In one arrangement, the interface module 220 controls a user interface 230 to provide a selection of available modes to an operator of the vehicle 100. In further arrangements, the interface module 220 may select a control mode having a mode interface that provides a highest level of information and functionality possible according to the system conditions 260. In relation to selecting the control mode, including a particular mode interface from the user interface 230, the interface module 220 provides a visual selection option to the operator within the user interface 230 that may include one or more available modes. Thus, the interface module 220 then receives a selection via an input signal from the operator selecting one of the available modes.

As such, the interface module 220 then generates the mode interface corresponding to the selected mode and may also provide controls to the vehicle 100 or cause the assistance system 160 to provide controls to the vehicle for controlling lateral and/or horizontal motion of the vehicle 100. In regards to the mode interface, the interface module 220 may generate different sets of information for the operator in a visual format depending on the selected mode. For example, the mode interface may include suggestions for safe driving speeds according to the current environmental conditions (e.g., due to visibility or road surface reduction in friction), average speeds of traffic, current braking performance (e.g., distance to a stop according to current conditions), safe following distances, maximum accelerations, and so on.

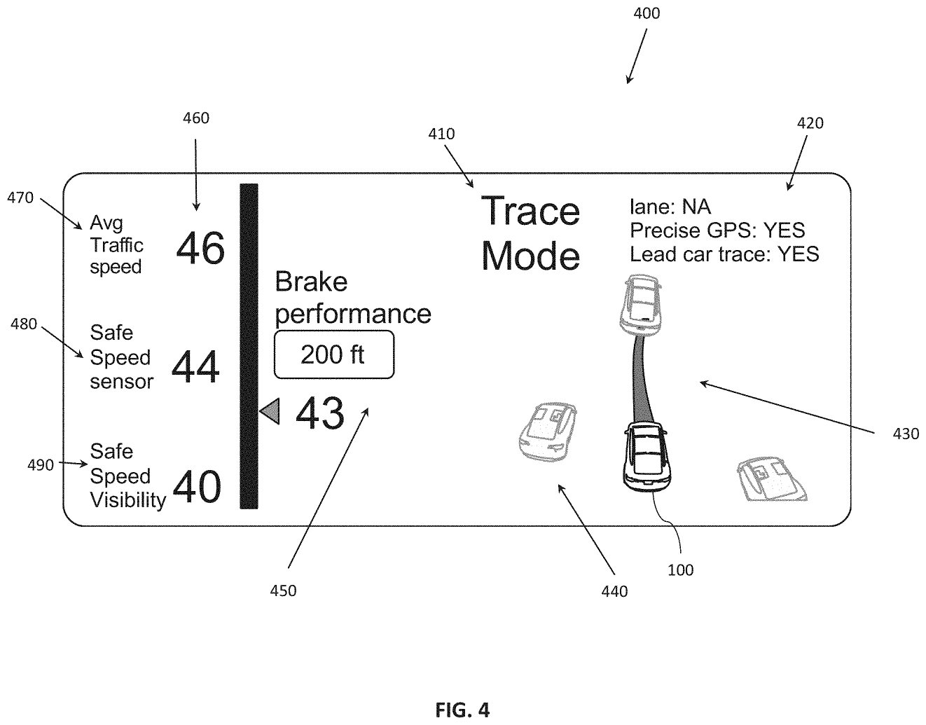

Moreover, the interface module 220 may generate the mode interface with different visualizations associated with information that is available to the assistance system 160. Thus, the interface module 220 may provide representations of the sensor data 250 depicting relative positions of hazards, types of hazards, path traces, and so on depending on the system conditions 260. Further explanation of the mode interfaces will be provided subsequently with reference to FIGS. 4-6.

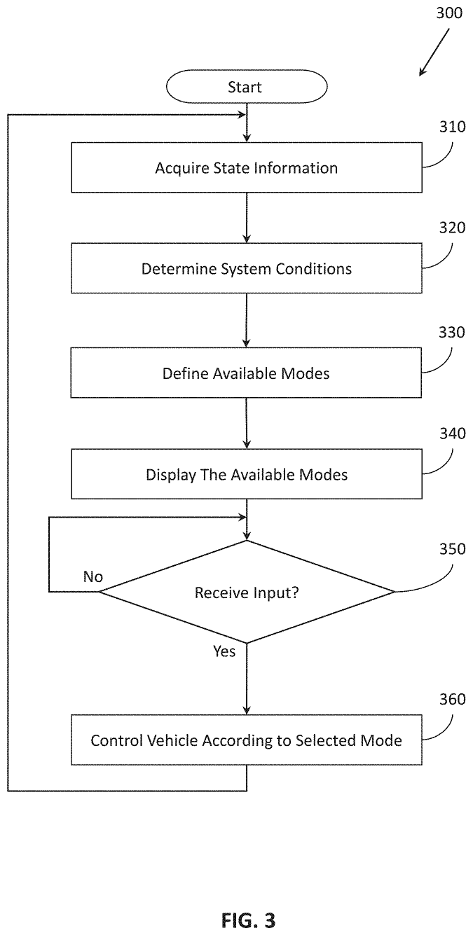

Additional aspects of providing cooperative control according to system conditions of a vehicle will be discussed in relation to FIG. 3. FIG. 3 illustrates a method 300 associated with determining system conditions and adapting an enacted mode. Method 300 will be discussed from the perspective of the monitoring system 170 of FIG. 1. While method 300 is discussed in combination with the monitoring system 170, it should be appreciated that the method 300 is not limited to being implemented within the monitoring system 170 but is instead one example of a system that may implement the method 300.

At 310, the interface module 220 acquires state information. In one embodiment, acquiring the state information includes acquiring the sensor data 250 along with, for example, operating state information about sensors and/or functions of the assistance system 160. The sensor data 250 is generally from at least one sensor of the vehicle 100. In one embodiment, the interface module 220 acquires the sensor data 250 about a surrounding environment of the vehicle 100 but may also acquire information about the vehicle 100 itself, such as IMU data, wheel slip data, and so on. The interface module 220, in one or more implementations, iteratively acquires the sensor data 250 from one or more sensors of the sensor system 120. The sensor data 250 includes observations of a surrounding environment of the subject vehicle 100, including specific regions that are relevant to functions executed by systems of the vehicle 100, such as assistance system 160 (e.g., activation zones, scanning zones, etc.), and so on.

At 320, the interface module 220 determines the system conditions 260. In one arrangement, the interface module 220 determines the system condition 260 to identify aspects associated with operation of functions of the assistance system 160. Thus, the system conditions 260 are generally based, at least in part, on environmental conditions around the ego vehicle 100 and how the assistance system 160 operates in cooperation with the sensors under these conditions. Of course, the interface module 220 may also operate independently of the environmental conditions to detect sensor failures, errors in functions of the assistance system 160, and so on. In any case, the interface module 220 analyzes state information regarding the functions and one or more sensors of the vehicle 100 to determine whether the functions and the one or more sensors are presently operable. The functions may include but are not limited to lane identification, localization, and path tracing for a preceding vehicle.

Moreover, in general, the interface module 220 determines the operability of the noted functions by determining aspects, such as whether certain features of the environment are perceivable for the present environmental conditions (e.g., whether lane lines or tire tracks are visible, whether surrounding objects are perceivable to an extent that they may be classified by semantic class, etc.), whether the functions are presently operating (e.g., error state), and so on. In this way, the interface module 220 can define the system conditions 260.

At 330, the interface module 220 defines available modes according to which control modes of the ego vehicle 100 can operate with the system conditions 260. That is, depending on the extent of assistance that the state conditions 260 identify is available, the interface module 220 correlates the control modes with the functions to identify which of the control modes are available based on the associated operating status. This may include determining whether particular sensors are functioning and sensor data is available such that certain functions are operable. In any case, the interface module 220 defines the set of available modes according to this analysis in order to subsequently inform the operator about options for assistance with the vehicle 100 and/or to automatically select an available mode.

At 340, the interface module 220 displays the available modes for selection by the operator. For example, in one arrangement, the interface module 220 controls the user interface 230 to display a list of the available modes. The list may be a scrolling set of example mode interfaces or a simple itemized listing indicating the available modes. In any case, the interface module 220 provides a visual about the available modes to the operator for selection.

At 350, the interface module 220 determines whether a selection for the available mode has been received or not. When a response is not received, the interface module 220 may automatically select one of the available modes after a defined period of time (e.g., a timeout). However, in general, the operator provides a selection through a human-machine interface (HMI) device that the interface module 220 then uses to activate the particular mode.

At 360, the interface module 220 controls the ego vehicle according to a selected mode of the available modes. In one arrangement, the interface module 220 provides a control input to the ego vehicle 100 to control a path of the ego vehicle 100 according to the selected mode. The assistance system 160 may originate the controls according to a request from the interface module 220 via the particular mode. The controls may vary depending on the particular selected mode, but can include lateral controls to cause the vehicle 100 to follow a path of a preceding vehicle in a trace mode, provide automatic braking to prevent collisions, limit accelerations to prevent slipping, and so on.

Moreover, the interface module 220 may display the mode interface to an operator of the ego vehicle 100 associated with the selected mode. The interface module 220, in at least one arrangement, generates and displays the mode interface according to the selected mode such that particular aspects that are relevant to the selected mode are visualized therein. The interface module 220 generates the mode interface to include a suggested control strategy for the operator to safely control the ego vehicle 100 in the environmental conditions. The suggested control strategy can include specifying a suggested speed for controlling the ego vehicle 100 in the environmental conditions, specifying safety margins about safe following distances in the environmental conditions, and so on.

Moreover, as a further aspect, the interface module 220 generates the mode interface to visually identify hazards in a surrounding environment of the ego vehicle 100. That is, depending on the sensor data 250 that is available, the quality of the sensor data 250, and the ability of the assistance system 160 to resolve features from the sensor data 250, the interface module 220 can render different visuals within the mode interface. The visuals may include simple object visualization relative to the vehicle 100, visibility indicators, and so on. Further examples of the visualizations will be illustrated in relation to FIGS. 4-6.

As a further explanation of how the presently disclosed systems and methods function, consider FIGS. 4-6. FIG. 4 illustrates a trace mode interface 400 associated with a trace mode. As shown, the interface 400 indicates the present mode 410 as the trace mode, and further indicates a status 420 of a lane identifying function as NA (e.g., not functioning), GPS as available, and lead car trace as available. The mode interface 400 further includes a visualization 430 of a path tracing function for a preceding vehicle that is currently being used to control lateral movements of the vehicle 100 while further providing an object detection display 440 about surrounding hazards of the vehicle 100 to show locations of particular types of objects. The mode interface 400 further includes a brake performance indicator 450 that shows a stopping distance for the vehicle 100 according to the current conditions. Furthermore, the mode interface 400 includes a display 460 of suggested controls showing an average traffic speed 470, a safe speed sensor 480, and a safe speed visibility 490. The safe speed sensor 480 indicates a safe speed for traveling upon which reliance indicates that vehicle is able to stop while safe speed visibility 490 indicates an estimated safe speed for control by the operator.

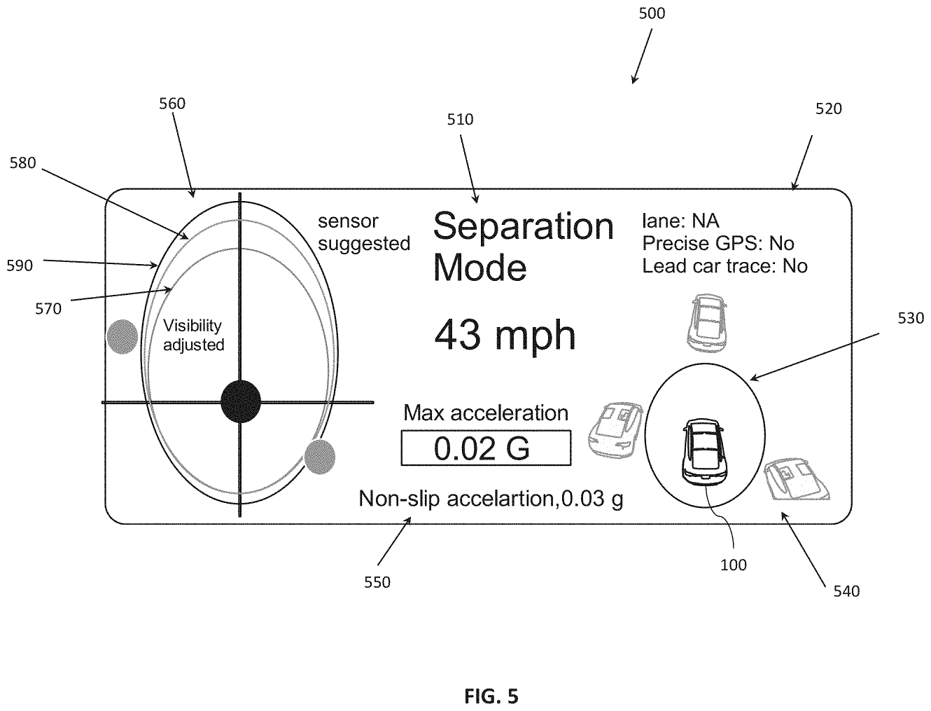

FIG. 5 illustrates a separation mode interface 500 associated with a separation mode. As shown, the interface 500 indicates the present mode 510 as the separation mode, and further indicates a status 520 of various functions, which are unavailable in this example (e.g., operating status that indicates unavailable or not functioning). The mode interface 500 further includes a visualization 530 of the separation function that may be implemented by the interface module 220 to control longitudinal braking/acceleration of the vehicle 100 to avoid slipping. The display elements 540 further depict nearby obstacles, such as other vehicles. The mode interface 500 further includes a max acceleration indicator 550 that is specified in gravitational units (g). The mode interface 500 further includes a display 560 illustrating different levels of visibility associated with an adjusted visibility 570 of the operator, a sensor suggested visibility 580, and a safety margin visibility 590 that is estimated by the vehicle 100 via the assistance system 160 using the sensor data 250. The separate visibilities 570-590 represent different capabilities of the operator and the sensors in for the present conditions in comparison to unimpeded perceptions.

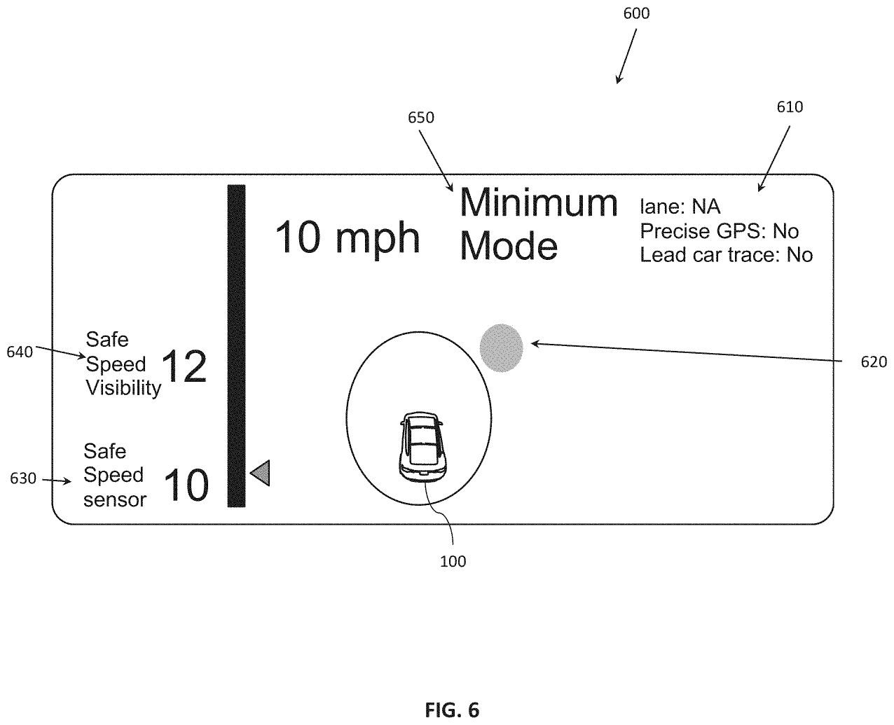

FIG. 6 illustrates a base mode interface 600 associated with a base mode. As shown, the interface 600 includes minimal information as the status 610 indicates a lack of available functions associated with the system conditions 260. Because of this, the interface module 220 may provide no controls to the vehicle 100 but still provides available sensor information and suggested controls. For example, the interface module 220 renders a visualization 620 of an unknown object in a position relative to the vehicle 100. However, further identification of a semantic class is not feasible because of the system conditions 260. As such, the object is shown as a simple geometric shape. The interface 600 further includes suggested controls 630, and 640 that are defined according to the system conditions 260. Suggested control 630 indicates a safe speed as determined by the sensors, whereas control 640 indicates a safe speed according to visibility. Indicator 650 shows a current speed of the vehicle 100.

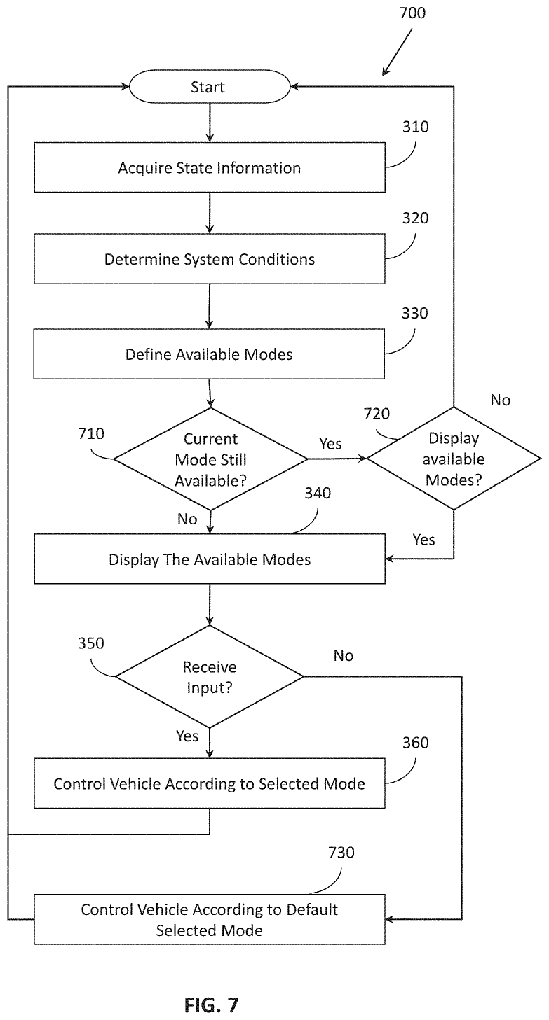

FIG. 7 illustrates an alternative arrangement of a method 700 in comparison to method 300 of FIG. 3. As shown, steps 310-360 remain generally similar to method 300. However, method 700 adds further elements. In one arrangement, the monitoring system 170 displays the mode list at 340, when a current mode is no longer available or about to become unavailable as defined by the system conditions. For example, if the current mode is no longer available, then the monitoring system 170 proceeds from this determination at block 710 to block 720. At 720, the operator may decide to view the available modes or not. In one configuration, the monitoring system 170 may provide a prompt to the operator to determine whether to display the available modes (e.g., in a heads-up display). In a further approach, the determination at 720 may occur according to an operator defined preference, such as do not disturb, a defined priority listing for modes, and so on.

At 350, the monitoring system 170 may receive an input from an operator about a selection from the available mode list. However, if the operator did not make a selection within a certain time (T). Then the system will change the mode based on a default selection at 730.

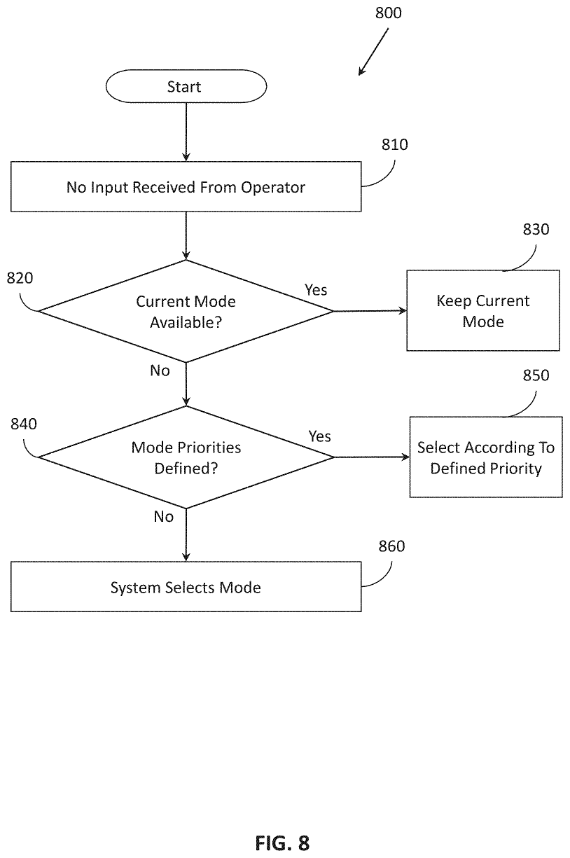

The default selection could be determined in many ways. One example provided here is shown in method 800 of FIG. 8. At 810, upon determining that there is no input from the operator (e.g., after a defined period of time), the monitoring system 170 begins to determine which mode to implement. For example, at 820, if the current modes is still available, the system 170 will use the current mode as default at 830.

Otherwise, at 840, when the current modes is not available, the system 170 will check the defined priority list for the operator to determine the default modes based on the priority list. For example, use the modes that gave the highest priority in the available modes at 850. The operator may define the priority list as a preconfiguration step.

At 840, if neither the current mode is available nor the defined priority list is provided, then the system 170 selects the default mode. For example, the system 170 selects the default mode that has the fewest differences to the current mode, in terms of, for instance, having the greatest overlap of automation features or most similar in control parameters. Alternatively, the system 170 can also select the default by using the available mode that presents the least risk for the driving conditions. In this way, the system 170 ensures selection of an available mode that is best suited for the driving conditions and the operator preferences. Additionally, it should be appreciated that the monitoring system 170 from FIG. 1 can be configured in various arrangements with separate integrated circuits and/or electronic chips. In such embodiments, the interface module 220 is embodied as a separate integrated circuit. The circuits are connected via connection paths to provide for communicating signals between the separate circuits. Of course, while separate integrated circuits are discussed, in various embodiments, the circuits may be integrated into a common integrated circuit and/or integrated circuit board. Additionally, the integrated circuits may be combined into fewer integrated circuits or divided into more integrated circuits. In further embodiments, portions of the functionality associated with the module 220 may be embodied as firmware executable by a processor and stored in a non-transitory memory. In still further embodiments, the module 220 is integrated as hardware components of the processor 110.

In another embodiment, the described methods and/or their equivalents may be implemented with computer-executable instructions. Thus, in one embodiment, a non-transitory computer-readable medium is configured with stored computer-executable instructions that, when executed by a machine (e.g., processor, computer, and so on), cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner. “Manual mode” means that all of or a majority of the navigation and/or maneuvering of the vehicle is performed according to inputs received from a user (e.g., human driver).

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is fully automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route. Such semi-autonomous operation can include supervisory control as implemented by the monitoring system 170 to ensure the vehicle 100 remains within defined state constraints.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 (e.g., data store 240) for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data. The map data can include maps of one or more geographic areas. In some instances, the map data can include information (e.g., metadata, labels, etc.) on roads, traffic control devices, road markings, structures, features, and/or landmarks in the one or more geographic areas. In some instances, the map data can include aerial/satellite views. In some instances, the map data can include ground views of an area, including 360-degree ground views. The map data can include measurements, dimensions, distances, and/or information for one or more items included in the map data and/or relative to other items included in the map data. The map data can include a digital map with information about road geometry. The map data can further include feature-based map data such as information about relative locations of buildings, curbs, poles, etc. In one or more arrangements, the map data can include one or more terrain maps. In one or more arrangements, the map data can include one or more static obstacle maps. The static obstacle map(s) can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level.

The one or more data stores 115 can include sensor data (e.g., sensor data 250). In this context, “sensor data” means any information from the sensors that the vehicle 100 is equipped with, including the capabilities and other information about such sensors.

As noted above, the vehicle 100 can include the sensor system 120. The sensor system 120 can include one or more sensors. “Sensor” means any device, component, and/or system that can detect, perceive, and/or sense something. The one or more sensors can be configured to operate in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100.

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself or interior compartments of the vehicle 100. In one or more arrangements, the vehicle sensor(s) 121 can be configured to detect and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system, and/or other suitable sensors. The vehicle sensor(s) 121 can be configured to detect and/or sense one or more characteristics of the vehicle 100. In one or more arrangements, the vehicle sensor(s) 121 can include a speedometer to determine a current speed of the vehicle 100. Moreover, the vehicle sensor system 121 can include sensors throughout a passenger compartment such as pressure/weight sensors in seats, seatbelt sensors, camera(s), and so on.

Alternatively, or in addition, the sensor system 120 can include one or more environment sensors 122 configured to acquire and/or sense driving environment data. “Driving environment data” includes data or information about the external environment in which an autonomous vehicle is located or one or more portions thereof. For example, the one or more environment sensors 122 can be configured to detect and/or sense obstacles in at least a portion of the external environment of the vehicle 100 and/or information/data about such obstacles. Such obstacles may be stationary objects and/or dynamic objects. The one or more environment sensors 122 can be configured to detect, and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described. As an example, in one or more arrangements, the sensor system 120 can include one or more radar sensors, one or more LIDAR sensors, one or more sonar sensors, and/or one or more cameras. In one or more arrangements, the one or more cameras can be high dynamic range (HDR) cameras or infrared (IR) cameras.

The vehicle 100 can include an input system 130. An “input system” includes, without limitation, devices, components, systems, elements or arrangements or groups thereof that enable information/data to be entered into a machine. The input system 130 can receive an input from a vehicle passenger (e.g., an operator or a passenger). The vehicle 100 can include an output system 140. An “output system” includes any device, component, or arrangement or groups thereof that enable information/data to be presented to a vehicle passenger (e.g., a person, a vehicle passenger, etc.).

The vehicle 100 can include one or more vehicle systems 150. Various examples of the one or more vehicle systems 150 are shown in FIG. 1, however, the vehicle 100 can include a different combination of systems than illustrated in the provided example. In one example, the vehicle 100 can include a propulsion system, a braking system, a steering system, throttle system, a transmission system, a signaling system, a navigation system, and so on. The noted systems can separately or in combination include one or more devices, components, and/or a combination thereof.

By way of example, the navigation system can include one or more devices, applications, and/or combinations thereof configured to determine the geographic location of the vehicle 100 and/or to determine a travel route for the vehicle 100. The navigation system can include one or more mapping applications to determine a travel route for the vehicle 100. The navigation system can include a global positioning system, a local positioning system or a geolocation system.

The processor(s) 110, the monitoring system 170, and/or the assistance system 160 can be operatively connected to communicate with the various vehicle systems 150 and/or individual components thereof. For example, returning to FIG. 1, the processor(s) 110 and/or the assistance system 160 can be in communication to send and/or receive information from the various vehicle systems 150 to control the movement, speed, maneuvering, heading, direction, etc. of the vehicle 100. The processor(s) 110, the monitoring system 170, and/or the assistance system 160 may control some or all of these vehicle systems 150 and, thus, may be partially or fully autonomous.

The processor(s) 110, the monitoring system 170, and/or the assistance system 160 can be operatively connected to communicate with the various vehicle systems 150 and/or individual components thereof. For example, returning to FIG. 1, the processor(s) 110, the monitoring system 170, and/or the assistance system 160 can be in communication to send and/or receive information from the various vehicle systems 150 to control the movement, speed, maneuvering, heading, direction, etc. of the vehicle 100. The processor(s) 110, the monitoring system 170, and/or the assistance system 160 may control some or all of these vehicle systems 150.

The processor(s) 110, the monitoring system 170, and/or the assistance system 160 may be operable to control the navigation and/or maneuvering of the vehicle 100 by controlling one or more of the vehicle systems 150 and/or components thereof. For instance, when operating in an autonomous mode, the processor(s) 110, the monitoring system 170, and/or the assistance system 160 can control the direction and/or speed of the vehicle 100. The processor(s) 110, the monitoring system 170, and/or the assistance system 160 can cause the vehicle 100 to accelerate (e.g., by increasing the supply of energy provided to the engine), decelerate (e.g., by decreasing the supply of energy to the engine and/or by applying brakes) and/or change direction (e.g., by turning the front two wheels).

Moreover, the monitoring system 170 and/or the assistance system 160 can function to perform various driving-related tasks. The vehicle 100 can include one or more actuators. The actuators can be any element or combination of elements operable to modify, adjust and/or alter one or more of the vehicle systems or components thereof to responsive to receiving signals or other inputs from the processor(s) 110 and/or the assistance system 160. Any suitable actuator can be used. For instance, the one or more actuators can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more modules that form the assistance system 160. The assistance system 160 can be configured to receive data from the sensor system 120 and/or any other type of system capable of capturing information relating to the vehicle 100 and/or the external environment of the vehicle 100. In one or more arrangements, the assistance system 160 can use such data to generate one or more driving scene models. The assistance system 160 can determine the position and velocity of the vehicle 100. The assistance system 160 can determine the location of obstacles, or other environmental features, including traffic signs, trees, shrubs, neighboring vehicles, pedestrians, and so on.

The assistance system 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The assistance system 160 either independently or in combination with the monitoring system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The assistance system 160 can be configured to implement determined driving maneuvers. The assistance system 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The assistance system 160 can be configured to execute various vehicle functions and/or to transmit data to, receive data from, interact with, and/or control the vehicle 100 or one or more systems thereof (e.g., one or more of vehicle systems 150).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, another magnetic medium, an ASIC, a CD, another optical medium, a RAM, a ROM, a memory chip or card, a memory stick, and other media from which a computer, a processor or other electronic device can read. In the context of this document, a computer-readable storage medium may be any tangible medium that can contain, or store a program for use by or in connection with an instruction execution system, apparatus, or device.

The following includes definitions of selected terms employed herein. The definitions include various examples and/or forms of components that fall within the scope of a term and that may be used for various implementations. The examples are not intended to be limiting. Both singular and plural forms of terms may be within the definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, includes one or more CMOS gates, combinations of gates, or other circuit components. Where multiple modules are described, one or more embodiments include incorporating the multiple modules into one physical module component. Similarly, where a single module is described, one or more embodiments distribute the single module between multiple physical components.

Additionally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A monitoring system, comprising:
one or more processors; and
a memory communicably coupled to the one or more processors and storing:
an interface module including instructions that, when executed by the one or more processors cause the one or more processors to
determine a system condition associated with operation of functions associated with an assistance system within an ego vehicle, the system condition being based, at least in part, on environmental conditions around the ego vehicle;
define available modes according to which control modes of the ego vehicle can operate with the system condition; and
control the ego vehicle according to a selected mode of the available modes.

2. The monitoring system of claim 1, wherein the interface module includes instructions to control the ego vehicle according to the selected mode including instructions to, in response to receiving a selection of the selected mode, provide a control input to the ego vehicle to control a path of the ego vehicle according to the selected mode, and display a mode interface to an operator of the ego vehicle associated with the selected mode.

3. The monitoring system of claim 2, wherein the interface module includes instructions to provide the control input including instructions to provide lateral controls to cause the ego vehicle to follow a path of a preceding vehicle.

4. The monitoring system of claim 1, wherein the interface module includes instructions to control the ego vehicle including instructions to generate and display a mode interface according to the selected mode,
wherein the interface module includes instructions to generate the mode interface including instructions to generate a suggested control strategy for an operator to safely control the ego vehicle in the environmental conditions, and
wherein the interface module includes instructions to generate the mode interface including instructions to visually identify hazards in a surrounding environment within the mode interface.

5. The monitoring system of claim 4, wherein the interface module includes instructions to generate the suggested control strategy including instructions to specify one or more of a suggested speed for controlling the ego vehicle in the environmental conditions, and safety margins about safe following distances in the environmental conditions.

6. The monitoring system of claim 1, wherein the interface module includes instructions to define the available modes including instructions to determine which of the control modes are operable in the environmental conditions as defined by the system condition identifying operating status for the functions, and displaying the available modes for selection by an operator.

7. The monitoring system of claim 1, wherein the interface module includes instructions to determine the system condition including instructions to analyze state information regarding the functions and one or more sensors of the ego vehicle to determine whether the functions and the one or more sensors can operate in environmental conditions.

8. The monitoring system of claim 1, wherein the functions include lane identification, localization, and path tracing for a preceding vehicle.

9. A non-transitory computer-readable medium storing instructions that, when executed by one or more processors, cause the one or more processors to:
determine a system condition associated with operation of functions associated with an assistance system within an ego vehicle, the system condition being based, at least in part, on environmental conditions around the ego vehicle;
define available modes according to which control modes of the ego vehicle can operate with the system condition; and
control the ego vehicle according to a selected mode of the available modes.

10. The non-transitory computer-readable medium of claim 9, wherein the instructions to control the ego vehicle according to the selected mode include instructions to, in response to receiving a selection of the selected mode, provide a control input to the ego vehicle to control a path of the ego vehicle according to the selected mode, and display a mode interface to an operator of the ego vehicle associated with the selected mode.

11. The non-transitory computer-readable medium of claim 10, wherein the instructions to provide the control input include instructions to provide lateral controls to cause the ego vehicle to follow a path of a preceding vehicle.

12. The non-transitory computer-readable medium of claim 9, wherein the instructions to control the ego vehicle include instructions to generate and display a mode interface according to the selected mode,
wherein the instructions to generate the mode interface include instructions to generate a suggested control strategy for an operator to safely control the ego vehicle in the environmental conditions, and
wherein the instructions to generate the mode interface include instructions to visually identify hazards in a surrounding environment within the mode interface.

13. A method, comprising:
determining a system condition associated with operation of functions associated with an assistance system within an ego vehicle, the system condition being based, at least in part, on environmental conditions around the ego vehicle;
defining available modes according to which control modes of the ego vehicle can operate with the system condition; and
controlling the ego vehicle according to a selected mode of the available modes.

14. The method of claim 13, wherein controlling the ego vehicle according to the selected mode includes, in response to receiving a selection of the selected mode, providing a control input to the ego vehicle to control a path of the ego vehicle according to the selected mode, and displaying a mode interface to an operator of the ego vehicle associated with the selected mode.

15. The method of claim 14, wherein providing the control input includes providing lateral controls to cause the ego vehicle to follow a path of a preceding vehicle.

16. The method of claim 13, wherein controlling the ego vehicle includes generating and displaying a mode interface according to the selected mode,
wherein generating the mode interface includes generating a suggested control strategy for an operator to safely control the ego vehicle in the environmental conditions, and
wherein generating the mode interface includes visually identifying hazards in a surrounding environment within the mode interface.

17. The method of claim 16, wherein generating the suggested control strategy includes one or more of specifying a suggested speed for controlling the ego vehicle in the environmental conditions, and specifying safety margins about safe following distances in the environmental conditions.

18. The method of claim 13, wherein defining the available modes includes determining which of the control modes are operable in the environmental conditions as defined by the system condition identifying operating status for the functions, and displaying the available modes for selection by an operator.

19. The method of claim 13, wherein determining the system condition includes analyzing state information regarding the functions and one or more sensors of the ego vehicle to determine whether the functions and the one or more sensors can operate in environmental conditions.

20. The method of claim 13, wherein the functions include lane identification, localization, and path tracing for a preceding vehicle.
